(19) United States
(12) Patent Application Publication
(10) Pub. No.: US 2026/0200549 A1
(43) Pub. Date: Jul. 16, 2026

(54) MAINTAINABLE AND REFITTABLE ELECTRIC BICYCLE AND DEVICES THEREOF

(71) Applicant: DATALAKE CO., LTD., New Taipei City (TW)

(72) Inventors: MENG-JIA HSIAO, New Taipei City (TW); YU-HSUAN LEE, New Taipei City (TW)

(21) Appl. No.: 19/019,962

(22) Filed: Jan. 14, 2025

(51) Int. Cl. B62M 6/50; B62J 43/13; B62J 45/20; B62J 45/40; B62J 50/22; B62M 6/60; B62M 6/90

(52) U.S. Cl. CPC B62M 6/50; B62J 43/13; B62J 45/20; B62J 45/40; B62J 50/22; B62M 6/60; B62M 6/90

(57) ABSTRACT

This disclosure provides a maintainable and refittable electric bicycle and devices thereof. The devices include a power-source system. The power-source system includes a battery, a battery management module, and a control module. The battery management module and the control module are integrated in an integrated control device. The power-source system is designed to be installed on an electric bicycle in order to control and manage supply of power for the electric bicycle. With the configuration, the battery and the modules can be integrated into the power-source system, and the only wiring work before the electric bicycle can be powered is to wire the power-source system to a driving device. This solves the problem of existing electric bicycles about complicated wiring and provides users with freedom to assemble and refit the electric bicycle.

### BACKGROUND OF THE DISCLOSURE

### 1. Technical Field

This disclosure relates to electric bicycles and devices thereof, and more particularly to a maintainable and refittable electric bicycle and devices thereof.

### 2. Description of Related Art

Existing electric bicycles often have complicated wiring. In particular, wiring around the handles involves connection of a large number of signal cables and control wires. The intricate network of cables and wires in the assembled wiring system adds difficulty in assembling and maintenance, making it almost impossible for untrained people to assemble or replace bicycle components by themselves. In other words, assembling works of existing e-bikes are something requires staff from factories or specialty shops.

Additionally, existing electric bicycles are usually designed with structures that are less maintainable and refittable, leaving the high demands for refittability and maintainability in the industry unmet.

### SUMMARY OF THE DISCLOSURE

The primary objective of this disclosure is to eliminate disadvantages of prior-art electric bicycles about complicated wiring, difficult maintenance, and low refittability.

To achieve the foregoing objective, this disclosure, in one embodiment, provides a maintainable and refittable electric-bicycle device, which comprises a power-source system. The power-source system comprises a battery, a battery management module, and a control module. The battery management module and the control module are integrated in an integrated control device. The power-source system can be installed on an electric bicycle in order to control and manage supply of power for the electric bicycle.

In another embodiment, this disclosure provides a maintainable and refittable electric bicycle, which comprises a bike body, a power-source system, and a driving device. The bike body has an installation mount. The power-source system comprises a battery, a battery management module, a control module, and a communication module. The battery management module, the control module, and the communication module are integrated in an integrated control device. The power-source system can be installed on the installation mount. The communication module is configured to perform data communication with an external wireless device. The driving device is installed at a hub of the electric bicycle and electrically connected to the power-source system.

With the modalized components and the integrated configuration, this disclosure significantly simplifies wiring in the electric bicycle. This makes replacement of the components and upgrade of the system more flexible, thereby improving the freedom of refit of the electric bicycle.

### BRIEF DESCRIPTION OF THE DRAWINGS

FIG. 1 is a block diagram showing a power-source system of this disclosure.

FIG. 2 is a perspective view of the disclosed power-source system.

FIG. 3 is a schematic drawing of a base of the disclosed power-source system.

FIG. 4 is a schematic drawing showing a human-machine interface device of this disclosure installed in a handle area of an electric bicycle.

FIG. 5 is a schematic drawing showing an operating device of this disclosure installed in a handle area of an electric bicycle.

FIG. 6 is a front view of the operating device of this disclosure.

### DETAILED DESCRIPTION OF THE DISCLOSURE

One or more preferred embodiments will be provided hereinafter for illustrating the concept of the present disclosure. However, it is to be understood that the components of the embodiment shown in the accompanying drawings are depicted for the sake of easy explanation and need not to be made to exact scale. In addition, some components may be partially or entirely omitted from the drawings, or some imaginary lines may be used for better clearness and easy understanding.

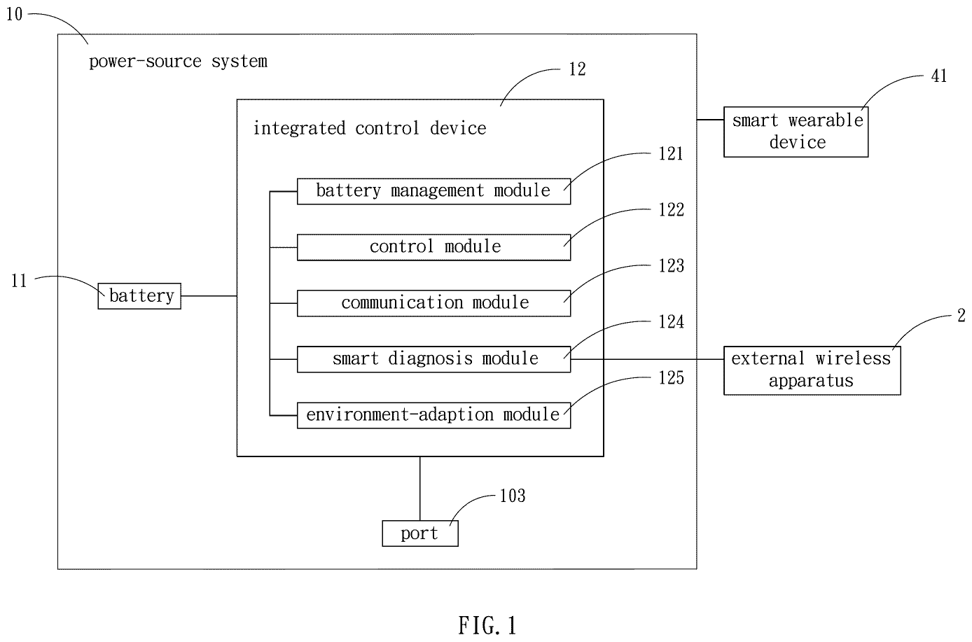

Referring to FIG. 1 through FIG. 6, this disclosure provides a maintainable and refittable electric-bicycle device, which comprises a power-source system 10. The power-source system 10 comprises a battery 11, a battery management module 121, and a control module 122. The battery management module 121 and the control module 122 are integrated in an integrated control device 12. The power-source system 10 is to be installed on an electric bicycle 1 in order to control and manage supply of power for the electric bicycle 1.

Therein, the integrated control device 12 further comprises a communication module 123. The communication module 123 is used to perform data communication with an external wireless device 2. Introduction of the communication module 123 enables the integrated control device 12 to implement wireless transmission of data. This facilitates management of the electric bicycle 1 by allowing a user to monitor the electric bicycle 1 remotely.

The communication module 123 may be a Bluetooth module, a Wi-Fi module, a cellular network module, or a near-field communication (NFC) module.

The external wireless device 2 may be a smart phone, a tablet, a smart watch, a laptop computer, a smart home control system, a wearable device, a vehicle-mounted navigation device, or any equipment capable of wireless communication. Any of these devices may be connected in a wireless manner to receive and/or display information about states of the electric bicycle 1, issue error messages, and/or provide relevant operational instructions.

Therein, the integrated control device 12 further comprises a smart diagnosis module 124. The smart diagnosis module 124 is in signal connection with a driving device 20 so as to analyze health of the battery 11 and the driving device 20 in a real-time manner, predict possible failure, and send diagnosis information to the external wireless device 2 through the communication module 123. The smart diagnosis module 124 is this contributive to preventive maintenance, thereby preventing sudden failure and enhancing the electric bicycle 1 in terms of reliability and service life.

Therein, the integrated control device 12 further comprises an environment-adaption module 125. The environment-adaption module 125 detects the temperature, the humidity, and the slope related to the environment in which the electric bicycle 1 is ridden in a real-time manner, and adjusts the discharge curve of the battery 11 according to the foregoing information for better efficiency and service life of the battery 11, thereby ensuring optimal performance of the electric bicycle 1 in various environment conditions.

In this disclosure, the battery management module 121 and the control module 122 are integrated in the integrated control device 12. This modularized design simplifies wiring works and adds flexibility in refit as compared to the prior art. In particular, the disclosure eliminates the entanglement of a signal cable and its related control wires in the handle area, so the handles can be replaced or refitted more easily. This endows a user with the freedom to change the handles in a conventional refitting practice of bicycles, without worrying about complicated wiring works. This not only makes maintenance simpler, but also encourages diverse refit of the electric bicycle 1. For instance, handles with an ergonomic design may be used to make riding more comfortable, or a set of handles with different features may be switched for different riding conditions. As a result, refit of the bicycle needs technical professionalism no more, and this provides more possibilities of personalization of the electric bicycle 1, thereby brining about more opportunities for third-party accessories.

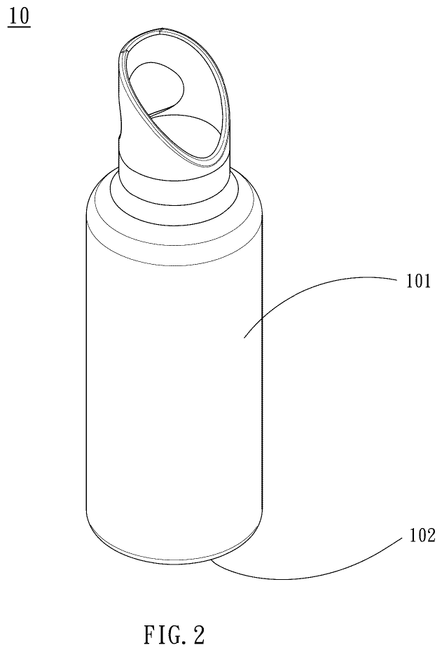

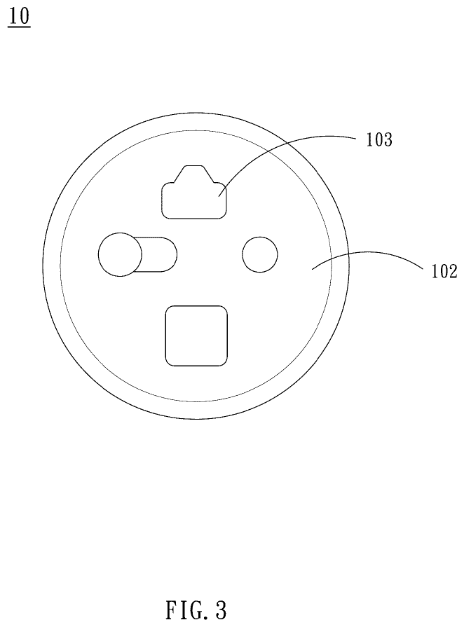

As shown in FIG. 2 and FIG. 3 in addition to FIG. 1, the power-source system 10 may be designed to have a bottle-like form. While the bottle-like form is shown herein, the power-source system 10 may be shaped otherwise. In the present embodiment, the power-source system 10 comprises a casing 101 and a base 102. The casing 101 contains therein the battery 11 and the integrated control device 12. The base 102 has a plurality of ports 103 connected to the integrated control device 12. The ports 103 are electrically connected to the integrated control device 12, respectively. When the ports 103 are connected to corresponding sockets provided on the electric bicycle 1, communication and power supply are provided to the electric bicycle 1, so that the electric bicycle 1 can be started to ride. The power-source system 10 in the bottle-like form is easy to install and carry. Since the ports 103 are all located in the base 102, they can be easily maintained and replaced by a user, and are well protected by the casing 101.

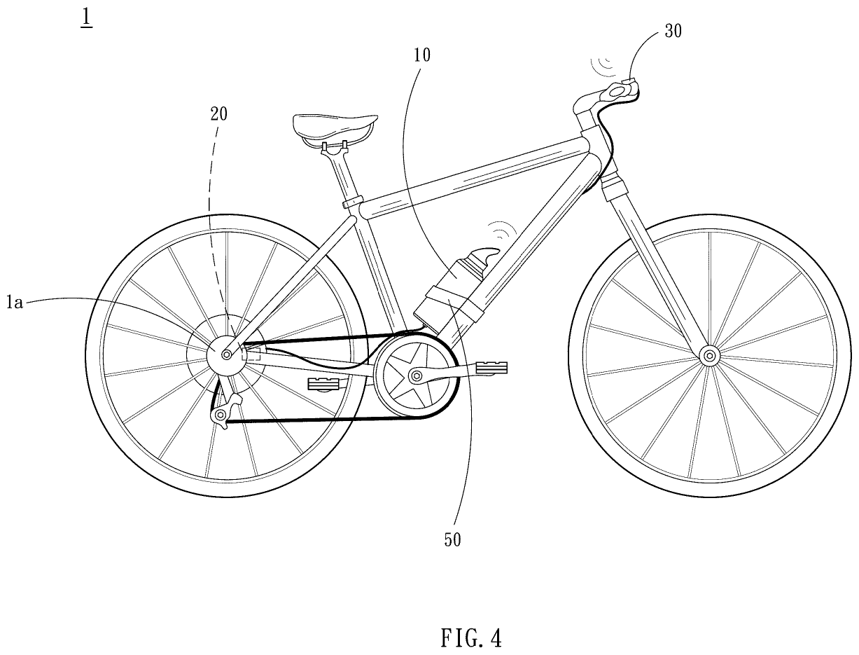

Referring to FIG. 4 plus FIG. 1, in another embodiment of this disclosure, a maintainable and refittable electric bicycle 1 comprises an installation mount 50, a power-source system 10, and a driving device 20. The installation mount 50 is attached to the electric bicycle 1. The power-source system 10 comprises a battery 11, a battery management module 121, and a control module 122. The battery management module 121 and the control module 122 are integrated in an integrated control device 12. The power-source system 10 is to be mounted on the installation mount 50.

Still referring to FIG. 4 together with FIG. 1, the driving device 20 is installed at a hub 1a of the electric bicycle 1 and electrically connected to the power-source system 10. Only a single cable is required to electrically connect the driving device 20 and the power-source system 10 before the electric bicycle 1 can be powered by the power-source system 10. This significantly simplifies works for wiring, installing and maintaining the components. By eliminating the complicated wiring as seen in the prior art, this disclosure effectively saves time required by assembling the components and reduces the risk of miswiring. This modularized design enables users to maintain or replace components by themselves and makes the bicycle more refittable.

Referring to FIG. 4 along with FIG. 1, this disclosure further comprises a human-machine interface device 30. The human-machine interface device 30 is electrically connected to the power-source system 10 and installed in the handle area of the electric bicycle 1 to display user information and provide control functions, so that a user can acquire various information about the electric bicycle 1 anytime during riding. Additionally, while this is not shown, the human-machine interface 30 may be alternatively installed in the body area of the electric bicycle 1.

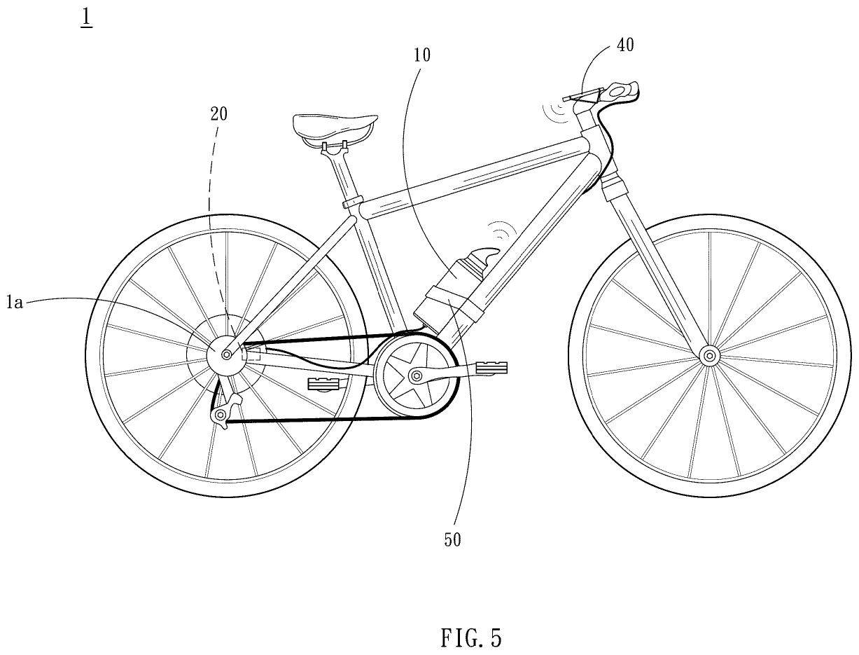

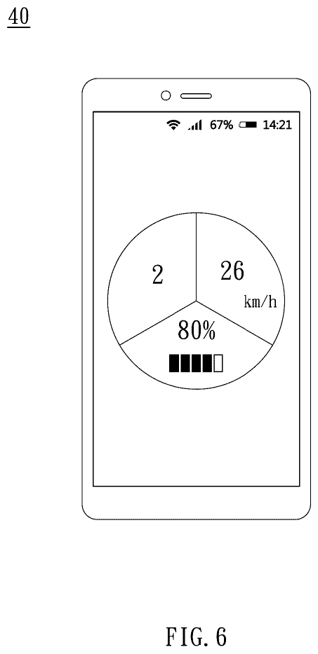

Referring to FIG. 5 and FIG. 6 as well as FIG. 1, this disclosure further comprises an operating device 40. The operating device 40 is electrically connected to the communication module 123 and installed in the handle area of the electric bicycle 1 to display status data of the electric bicycle 1 and provide control operations, so that a user can acquire various information about the electric bicycle 1 anytime during riding. The operating device 40 may be a smart phone or a tablet. The operating device 40 may be installed with specialized software for controlling the electric bicycle 1 so as to provide diverse control functions, such as switching among different riding modes, checking the state-of-charge of the battery 11, setting the maximum speed, and diagnosing health of the bicycle. Through wireless data communication, the operating device 40 may receive real-time operational data from the electric bicycle 1, and show the data to the user through intuitive interface, so that the user can manage the operational states and state changes of the electric bicycle 1 conveniently. Moreover, a smart wearable device 41 may be electrically connected to the power-source system 10, so as to display user information and provide control functions to a user wearing it. The smart wearable device 41 may be a smart watch, a smart bracelet, smart glasses, or a head-mounted device.

Furthermore, by making the operating device 40 cover the display function for the electric bicycle 1, hardware costs for providing a separate display screen can be saved. The screen built in the operating device 40 can show all status data and information about the electric bicycle 1. Elimination of a separate display screen also helps reduce costs for producing and assembling the electric bicycle 1.

In this disclosure, the integrated control device 12 integrates the battery management module 121, the control module 122, and other functional modules (e.g., the communication module 123, the smart diagnosis module 124, etc.) as a unity, and combines various signal cables and control wires into a few primary electrical connections. This reduces complexity of wiring in the electric bicycle 1 and contributes to not only simplified wiring works but also significantly reduced likeliness of miswiring, which leads to higher assembling efficiency and better system stability.

Additionally, since the integrated control device 12 is essentially of a modularized structure, it can be easily connected to accessories and plug-in devices from different manufacturers. For example, an old power-source system 10 can be easily removed and replaced with a new power-source system 10 that has higher capacity, or control interface devices with different features, such as the human-machine interface device 30 or the operating device 40 may be installed, or other smart devices may be used to improve smart riding experience, or to support third-party accessories. All of these can eventually promote more diversified development in the electric bicycle industry.

The present disclosure has been described with reference to the preferred embodiments and it is understood that the embodiments are not intended to limit the scope of the present disclosure. Moreover, as the contents disclosed herein should be readily understood and can be implemented by a person skilled in the art, all equivalent changes or modifications which do not depart from the concept of the present disclosure should be encompassed by the appended claims.

What is claimed is:

1. A maintainable and refittable electric-bicycle device, comprising:
a power-source system, comprising a battery, a battery management module, and a control module, wherein the battery management module and the control module are integrated in an integrated control device, the power-source system being configured to be installed on an electric bicycle in order to control and manage supply of power for the electric bicycle.

2. The maintainable and refittable electric-bicycle device of claim 1, wherein the integrated control device further comprises a communication module, which is configured to perform data communication with an external wireless device.

3. The maintainable and refittable electric-bicycle device of claim 2, further comprising a driving device, which is installed at a hub of the electric bicycle and electrically connected to the power-source system so that the power-source system controls operations of the driving device.

4. The maintainable and refittable electric-bicycle device of claim 3, wherein the integrated control device further comprises a smart diagnosis module, which is in signal connection with the driving device in order to analyze health of the battery and the driving device in a real-time manner, to predict possible failure, and to send diagnosis information to the external wireless device through the communication module.

5. The maintainable and refittable electric-bicycle device of claim 4, further comprising an operating device, which is electrically connected to the communication module and is installed in a handle area or a body area of the electric bicycle in order to display status data of the electric bicycle and to provide control operations.

6. The maintainable and refittable electric-bicycle device of claim 1, further comprising a human-machine interface device, the human-machine interface device electrically connected to the power-source system, and is installed in a handle area or a body area of the electric bicycle in order to display user information and to provide control functions.

7. The maintainable and refittable electric-bicycle device of claim 1, wherein the integrated control device further comprises an environment-adaption module, which detects a temperature, a humidity, and a slope related to an environment in which the electric bicycle is ridden in a real-time manner, and adjusts a discharge curve of the battery accordingly for better efficiency and service life of the battery.

8. A maintainable and refittable electric bicycle, comprising:
an installation mount, being attached to the electric bicycle;
a power-source system, comprising a battery, a battery management module, a control module, and a communication module, wherein the battery management module, the control module, and the communication module are integrated in an integrated control device, the communication module being configured to perform data communication with an external wireless device, and the power-source system being configured to be mounted on the installation mount; and
a driving device, being installed at a hub of the electric bicycle and electrically connected to the power-source system.

9. The maintainable and refittable electric bicycle of claim 8, further comprising an operating device, which is electrically connected to the communication module, and is installed in a handle area or a body area of the electric bicycle in order to display status data of the electric bicycle and to provide control operations.

10. The maintainable and refittable electric bicycle of claim 8, further comprising a human-machine interface device that is electrically connected to the power-source system, and is installed in a handle area or a body area of the electric bicycle in order to display user information and to provide control functions.

11. The maintainable and refittable electric bicycle of claim 8, further comprising a smart wearable device that is electrically connected to the power-source system in order to display user information and to provide control functions.
